(19) United States
(12) Patent Application Publication
(10) Pub. No.: US 2026/0161183 A1
(43) Pub. Date: Jun. 11, 2026

(54) GROUP OF UNMANNED AERIAL VEHICLES MISSION CONTROL SYSTEM FOR GEOPHYSICAL EXPLORATION

(71) Applicant: SAUDI ARABIAN OIL COMPANY, Dhahran (SA)

(72) Inventors: Valerii Serpiva, Moscow (RU); Artem Timoshenko, Moscow (RU); Grigoriy Yashin, Moscow (RU); Pavel Golikov, Dhahran (SA)

(73) Assignees: Aramco Innovations LLC, Moscow (RU); SAUDI ARABIAN OIL COMPANY, Dhahran (SA)

(21) Appl. No.: 18/712,559

(22) PCT Filed: Jun. 16, 2023
(86) PCT No.: PCT/RU2023/000188

§ 371 Date: May 22, 2024

(51) Int. Cl. G05D 1/693; B64F 5/60; B64U 20/80; B64U 50/39; G05D 1/226; G05D 105/80; G05D 109/20; G08G 5/32; G08G 5/80

(52) U.S. Cl. CPC G05D 1/693; B64F 5/60; B64U 20/80; B64U 50/39; G05D 1/226; G08G 5/32; G08G 5/80; G05D 2105/87; G05D 2109/20

(57) ABSTRACT

The invention refers to a system and a method for controlling a plurality of unmanned arial vehicles (UAV) and a non-transitory computer readable medium. The system comprises a processor and a transceiver to be accommodated on each of the plurality of UAVs and a control station. The method comprises transmitting to the plurality of UAVs, from the control station, input mission parameters for performing a task in an exploration area, including initial and target position of each UAV, determining, by the control station, an optimal flight path for each UAV, and generating a mission plan and flying paths for the plurality of UAVs where the plurality of UAVs does not collide with one another and with environmental obstacles. The invention provides increasing the efficiency of controlling a plurality of UAVs.

### BACKGROUND

Unmanned Aerial Vehicles (UAV) such as drones can be widely used for geophysical exploration. Often traditional geophysical explorations take place over large exploration areas. This results in various challenges. For example, onshore seismic acquisition may require placement of a lot of equipment (e.g., thousands of sensors and auxiliary equipment), manual operations on a large area, difficult terrain, or significant surface infrastructure that needs complex logistics. To overcome at least some of these challenges, a large number of UAVs can be equipped with specific sensors, data recording, and communication systems. The UAVs can reach remote areas for exploration. However, exploration with a large number of UAVs requires a real-time control system with a user interface to effectively manage mission parameters and status of the UAVs.

### SUMMARY

This summary is provided to introduce a selection of concepts that are further described below in the detailed description. This summary is not intended to identify key or essential features of the claimed subject matter, nor it is intended to be used as an aid in limiting the scope of the claimed subject matter.

This disclosure presents, in accordance with one or more embodiments, a system for controlling a plurality of unmanned arial vehicles (UAV). The system includes: the plurality of UAVs, wherein each of the plurality of UAVs includes a first processor and a first transceiver; and a control station including a second processor and a second transceiver. The first transceiver receives, from the second transceiver, input mission parameters for performing a task in an exploration area. The first transceiver receives, from the second transceiver, at least one initial position of each UAV and at least one target position of the exploration area. The second processor determines an optimal flight path between the at least one initial position of each UAV and the at least one target position of the exploration area. The second processor generates a grid that comprises the at least one target position of the exploration area. The second processor generates a mission plan and flying paths for the plurality of UAVs where the plurality of UAVs does not collide with one another and with environmental obstacles.

In another aspect, this disclosure also presents, in accordance with one or more embodiments, a method for controlling a plurality of UAV. The method includes: transmitting to the plurality of UAVs, from a control station, input mission parameters for performing a task in an exploration area; transmitting to each of the plurality of UAVs among the plurality of UAVs, from the control station, at least one initial position of the each UAV and at least one target position of the exploration area; transmitting to the control station real-time information from each UAV; determining, by the control station, an optimal flight path between the at least one initial position of each UAV and the at least one target position of the exploration area; generating, by the control station, a grid that comprises the at least one target position of the exploration area; and generating, by the control station, a mission plan and flying paths for the plurality of UA Vs where the plurality of UAVs does not collide with one another and with environmental obstacles.

In another aspect, this disclosure also presents, in accordance with one or more embodiments, a non-transitory computer readable medium (CRM) storing instructions for performing operation that controls a plurality of UAV. The operation includes: transmitting to the plurality of UAVs, from a control station, input mission parameters for performing a task in an exploration area; transmitting to each of the plurality of UAVs among the plurality of UAVs, from the control station, at least one initial position of the each UAV and at least one target position of the exploration area; transmitting to the control station real-time information from each UAV; determining, by the control station, an optimal flight path between the at least one initial position of each UAV and the at least one target position of the exploration area; generating, by the control station, a grid that comprises the at least one target position of the exploration area; and generating, by the control station, a mission plan and flying paths for the plurality of UA Vs where the plurality of UAVs does not collide with one another and with environmental obstacles.

Other aspects and advantages of the invention will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an exemplary system including unmanned arial vehicles (UAV) and a control station, in accordance with one or more embodiments disclosed herein.

FIG. 2 shows an example of deploying groups of UAVs to an exploration area, in accordance with one or more embodiments disclosed herein.

FIG. 3A shows an example of exploration of groups of UAVs in an exploration area, in accordance with one or more embodiments disclosed herein.

FIG. 3B shows an example of exploration of UAVS in an exploration area, in accordance with one or more embodiments disclosed herein.

FIG. 4 shows a control station and UAVs, in accordance with one or more embodiments disclosed herein.

FIG. 5 shows software of a control station, in accordance with one or more embodiments disclosed herein.

FIG. 6 shows software of a UAV, in accordance with one or more embodiments disclosed herein.

FIG. 7 shows a flow chart for operating a system, the system including a control station and a plurality of UAVs, in accordance with one or more embodiments disclosed herein.

FIG. 8 shows a computer system for operating a system, the system including a control station and a plurality of UAVs, in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the disclosure, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements. In addition, throughout the disclosure, “or” is interpreted as “and/or,” unless stated otherwise.

One or more embodiments disclosed herein describe a system including a control station and a plurality of UAVs. The control station, which may be a ground control station (GCS), controls operation of the UAVs for exploration. The exploration may be, for example, geophysical exploration such as acquiring seismic data. Each of the control station and the plurality of UAVs include hardware modules and algorithms for executing acquisition (e.g., geophysical acquisition) and data recording by the plurality of UAVs and using time and resources effectively. The control station includes algorithms and methods for flight mission planning, task management, user interface, and communication units. Each UAV includes a control unit including a processor for controlling the mission, self-diagnose, and operating communication units and peripheral devices on the UAV. The peripheral devices may be sensors or mechanized payload controller(s). The sensors may include at least a seismic sensor for recording acoustic waves, at least an infrared sensor, at least an ultraviolet sensor, at least a radio frequency (RF) sensor, at least a visible-range camera, at least a distance sensor, or a global positioning system (GPS), or any combination thereof. The infrared sensor, ultraviolet sensor, RF sensor, visible-range camera, distance sensor, or GPS may be used by the UAVs or by the control station to detect and go around obstacles while flying, for example during the mission plan.

The control station distributes tasks between the plurality of UAVs according to requirements of the exploration. The control station may consider mission parameters, environmental obstacles, or features of UAVs to generate a path for the UAVs without collisions between the UAVs and between the UAVs and other objects. The control station may also consider trajectory of a signal source (if the signal source is present). The signal source may be, for example, a seismic signal source that generates acoustic waves. In another example, the signal source may be an electromagnetic wave signal source. The control station can manage the mission plan, receive status of the UAVs, and send commands by communication unit(s).

According to one or more embodiments, the control station may include a user interface to set input mission parameters for UAVs, prepare a flight mission plan (i.e., mission plan or flight plan), and manage mission progress. The control station may generate trajectories for the UAVs without collision of the UAVs with obstacles or one another. For example the control station may generate the trajectories for the UAVs without intersection (in three dimensions) for simultaneous flight of the UAVs or with intersections for distributed flight of the UAVs in time. For the scenario of no intersection for simultaneous flight, the UAVs may be coordinated to have different flying altitudes or ground coordinates from one another. The control station may generate the trajectories and flying patterns of the UAVs based on the mission plan and based on the exploration area. The control station may group the UAVs into a plurality of groups in various spatial formations, depending on the requirements of the exploration. The control station may require the UAVs to include a self-diagnostic module to autonomously check correctness of the entered input parameters for the exploration and to monitor the status of UAVs in real-time. The control station may schedule battery replacements of the UAVs with minimal mission downtime.

In one or more embodiments, a UAV decentralized control system includes a main computing module (e.g., microprocessor), autopilot, and controllers for peripheral devices (e.g., obstacle detecting sensors, a data recording system, mechanized payload controller, etc.). The UAV decentralized control system may require data exchange between the control station and the UA Vs over short and long distances using two types of transmitters in accordance with the distance between the control station and the UAVs.

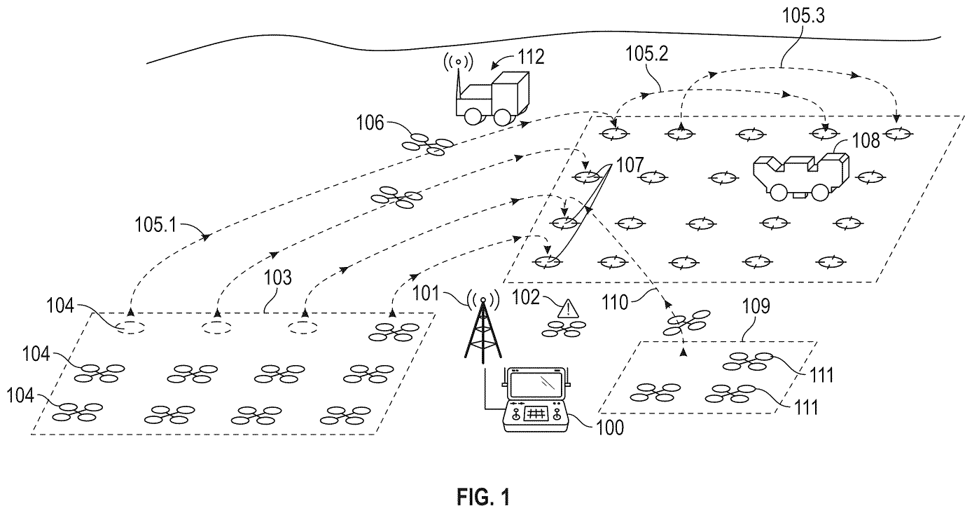

The following description further explains the system including the control station and UAVs, in accordance with one or more embodiments, with reference to FIGS. 1 to 8.

FIG. 1 shows an exemplary system including UAVs (104, 106) and a control station (100), in accordance with one or more embodiments disclosed herein. The control station (100) may control autonomous geophysical exploration of the UAVs (106). The system includes the control station (100), which is a GCS in this example, UAVs (106), and a signal source (108). The signal source (108) may generate, for example, electromagnetic pulses or seismic waves. The system further includes a communication system (101), spare UAVs (111) in a launch area (109).

Initially, the control station (100) generates a mission plan (i.e., flight plan) for the UAVs (104, 106) to fly from their initial positions (104) in a base area (103) to their target positions (107) for geophysical acquisition. The mission plan assumes a set of UAV flight trajectories (105.1, 105.2, 105.3) and functional tasks performed by the UAVs (106). The flight trajectories (105.1, 105.2, 105.3) may be the optimal flight paths (e.g., optimized based on fuel efficiency, time, or obstacles in the exploration area), or minimum flight paths (minimum in time or space) for the UAVs to arrive at the target positions (107). The functional tasks may be, for example, takeoff, landing, start of data recording, etc. The functional tasks are tasks required by the mission plan to perform the geophysical exploration.

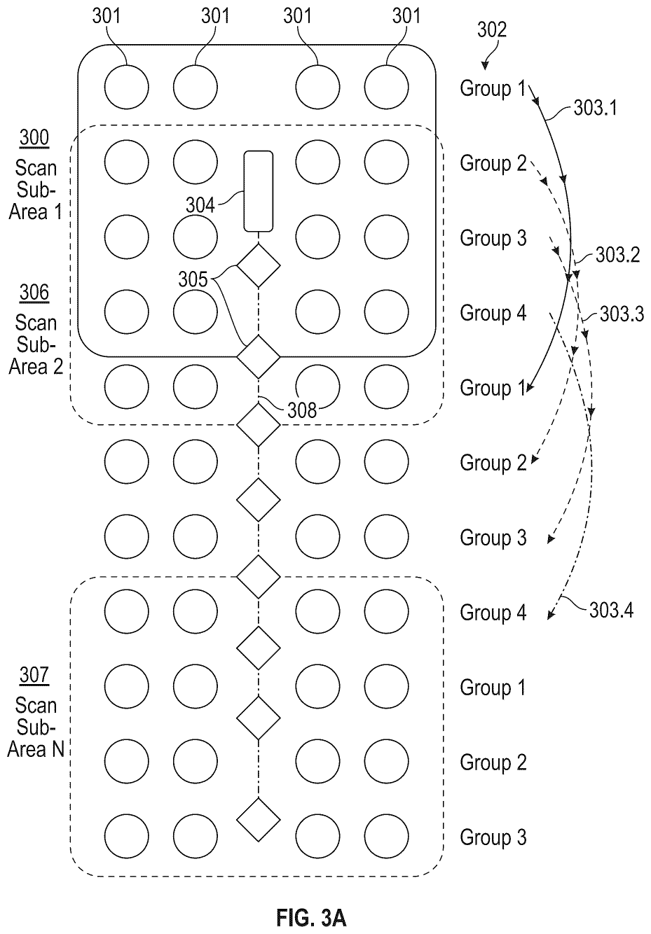

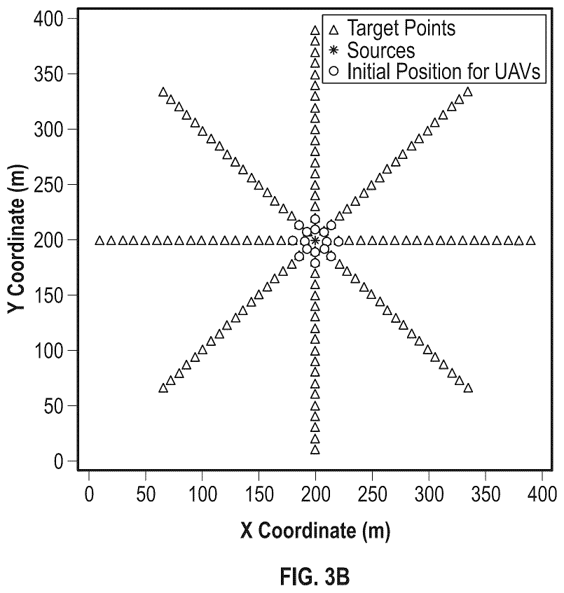

During the mission plan, a faulty UAV (102) may not be able to continue performing tasks received from the control station (100). For example, the faulty UAV (102) may be low on battery charge (i.e., being low-charge) or may have a functional issue such as breakdown of a component (e.g., an electric motor, a transceiver, a propeller, etc.). In this event, the system replaces the faulty UAV (102) with a spare UAV (111) located in the launch area (109) and sends the spare UAV (111) along a new trajectory (110) to replace the faulty UAV (102) for continuing the mission plan. In one or more embodiments, the control station can monitor the battery charge of the UAVs (106) and provide actual information to an operator or a service group (112) who maintain(s) the UAVs (106, 102, 111). The service group (112) maintains the last row of the UAVs. The last row is a group of UAVs which is going to take off. It is a last line in a scan sub-area (for example in FIG. 3A described further below, in sub-area 1 (300 ) the last row is group 1 (302)). After arriving at the target positions, a group will land and wait for next flight when other rows move to next positions.

While the service group (112) maintains the last row of the UAVs, spare UAVs from launch area (109) can be used on the mission. For example, the service group (112) will change batteries of the last row of the UAVs that have low charge, according to a mission schedule. After flight of the last row, the service group (112) will repair or replace the faulty UAVs of the next row to the last row and so forth until all of the UAVs in the launch area (109) are repaired or replaced. For example, the service group (112) will replace batteries of the next row of the UAVs having low charge and so forth, until batteries of all UAVs that have low charge are replaced or charged. This approach allows the service group (112) to replace or charge all of the batteries quickly and without long mission interruptions. In one or more embodiments, several service groups (112) can maintain the UAVs (106, 102, 111) in a mission to speed up the battery replacement or charging procedure.

The UAVs can be grouped into several groups for different tasks. For example, one group can scout the exploration field or make 3D virtual construction (i.e., 3D-point cloud) of the ground surface and obstacles. For example, one or more of the UAVs can be equipped with LiDAR sensor(s) for 3D-reconstruction of the exploration area. Using this data, the control station can generate the mission plan and divide the UAVs into a number of groups of UAVs, which may be equipped with seismic sensors, to fly to target positions for geophysical exploration. In another example, one group of UAVs may be equipped with one or more electromagnetic sources and another/other group(s) of UAVs may be equipped with receivers to perform electromagnetic analysis of the electromagnetic waves/pulses generated by the one or more electromagnetic sources and coming from the ground. Depending on the type of electromagnetic analysis or signal propagation from the one or more electromagnetic sources, the groups of the UAVs may be required by the control station to form specific spatial formation(s)/shape(s) (e.g., circle, triangle, rectangle, line, complex shapes, etc., or a combination thereof). The control station determines the spatial formation(s)/shape(s) of the UAVs based on requirements of the mission plan or based on the location or trajectory of the signal source. For example, the formation(s)/shape(s) of the UAVs (e.g., the geometrical shape of the groups, relative distance between adjacent groups, or relative distance between adjacent UAVs in a group) may be determined based on the terrain, specifics of the electromagnetic pulses, movement of the signal source, etc., or any combination thereof. Each group of UAVs receives the mission plan from the control station to perform their specific functions.

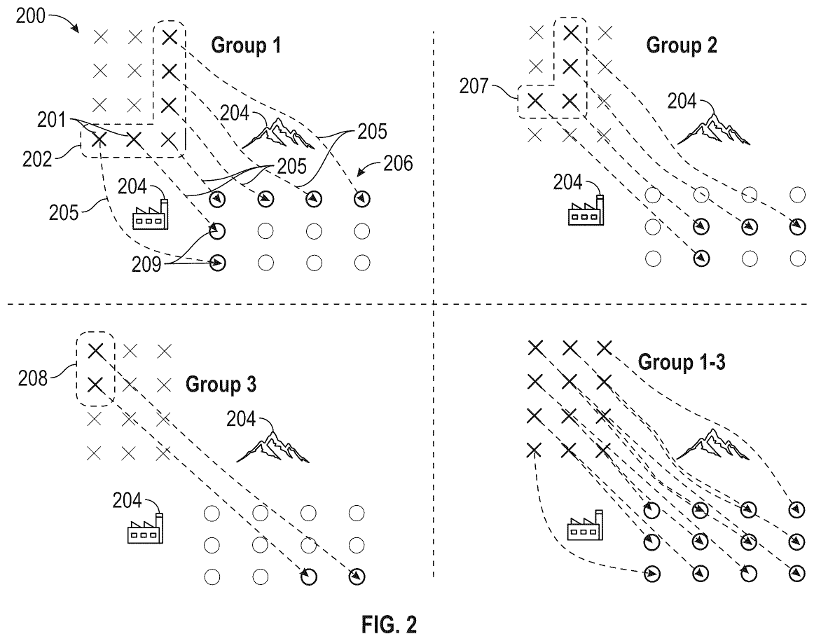

FIG. 2 shows an example of grouping the UAVs into a plurality of groups of UAVs, namely Group 1 (202), Group 2 (207), and Group 3 (208), and deploying the groups of UAVs (202, 207, 208) for the mission plan, in accordance with one or more embodiments disclosed herein. The UAVs fly from the initial positions (200) to the target positions (206, 209). The initial positions (200) are shown by the crosses (“x”) and the target positions (206) are shown by circles (“○”). A flight mission planner of the control station, which will be described further below, determines the optimal shape/formation of the UAVs for the geophysical exploration, distributes the target positions (206) between the UAVs that are initially located at the initial positions (200), and generates global flight paths (205) for the UAVs.

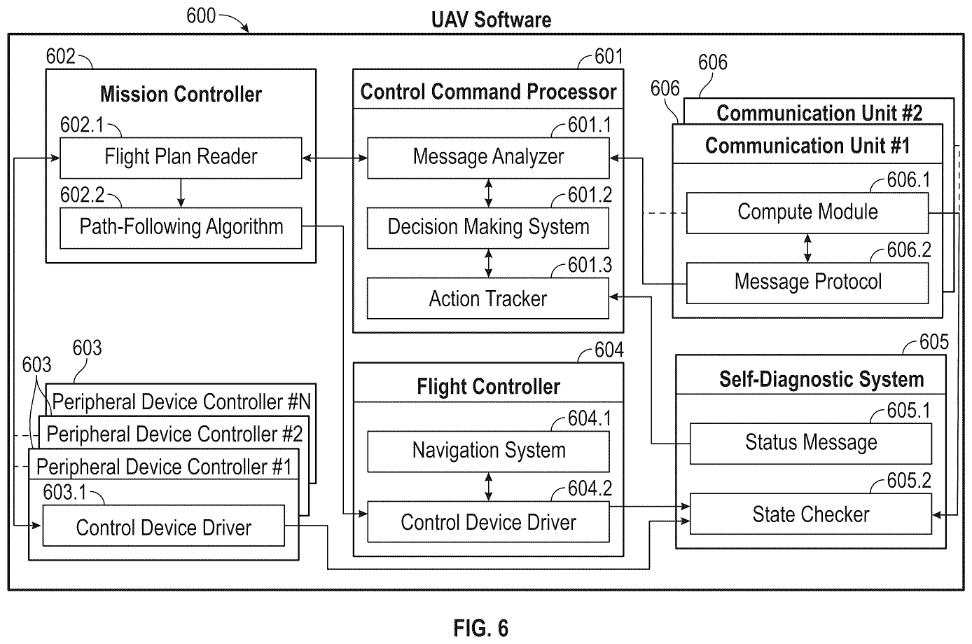

The global flight paths (205) include geo-positions (such as latitude, longitude, and/or altitude) or local coordinates relative to the control station. The UAVs follow the global flight paths using path-following algorithm, which will be described further below with reference to FIG. 6. During the flight, the UAVs or control station may build local paths using visual sensors, to avoid unforeseen obstacles that were not considered in the global flight paths (205).

The shape/formation for the geophysical exploration is the shape/formation of the overall target positions (206), which are recording points subject to the geophysical exploration. The example of shape/formation for the geophysical exploration shown in FIG. 2 is a rectangle shape that is formed by the target positions (206). The parameters of shape/formation for the geophysical exploration may also include the distance between the target positions (206), target altitudes (e.g., hovering altitudes of the UAVs for recording data), or orientation of the UAVs.

A point distributor of the control station, which also will be described further below, calculates the intermediate trajectories and points between the initial positions (200) and target positions (206) for each of the UAVs (201). For this, the point distributor of the control station considers collision avoidance between the UAVs with one another and between the UAVs and industrial or environmental obstacles (204). The point distributor groups the UAVs into several groups (202, 207, 208) and distribute trajectories independently for each group (202, 207, 208). The distribution of the trajectories may be at different altitudes for different groups (202, 207, 208). In this case, the global flight paths (205) (i.e., trajectories) may be generated with without intersections, considering the range and route, and may be distributed by different flight altitudes, latitudes, or longitudes) to avoid collisions between the groups (202, 207, 208). In one or more embodiments, the global flight paths (205) may be generated with intersections when the groups (202, 207, 208) are not flying simultaneously.

The control station generates the global flight paths (205) via a planner algorithm, which will be described further below, considering obstacles (204) such as industrial buildings and natural terrain. The collision avoidance with obstacles (204) can be implemented using search algorithms such as graph search algorithms, artificial potential fields, sampling-based, optimization methods, etc.

Accordingly, the control station can coordinate the flight of all of Group 1 (202), Group 2 (207), and Group 3 (208) to the target positions (206), as shown in the bottom right quarter of FIG. 2. In one or more embodiments, the control section may fly Group 1 (202), Group 2 (207), and Group 3 (208) separately in time. Alternatively, in one or more embodiments, the control station may fly Group 1 (202), Group 2 (207), and Group 3 (208) all together in form of a swarm. While FIG. 2 shows only three groups of UAVs (202, 207, 208), the control station may group the UAVs into any number of groups depending on a specific geophysical exploration and UAVs' capabilities.

FIG. 3A shows an example of exploration of groups of UAVs (302), their movements, and data recording with respect to a seismic signal source (304) in an autonomous geophysical exploration, in accordance with one or more embodiments disclosed herein. The whole exploration area is virtually divided, by the control station, into scan sub-areas 1 to N (300, 306, 307). Each scan sub-area (300, 306, 307) includes several groups of UAVs (302). In this example, the groups (302) are in the form of lines. However, the groups may have other spatial formations depending on specifics and requirements of the geophysical exploration, for example requirements of the mission plan, location of the signal source (304), or trajectory of the signal source (305). Specifically, depending on the requirements for the geophysical exploration, the UAVs can be grouped into various formations such as triangle, rectangle, circle, or other complex geometrical formations. For example, when the signal source (304) moves on a linear trajectory, the groups of UAVs may form a linear or rectangular formation, for example as shown in FIG. 3A. On the other hand, when the signal source is stationary, for example as shown further below with reference to FIG. 3B, the UAVs may for a circle.

Further, in one or more embodiments different groups of UAVs may have different formations. For example, a first group may have a line formation, a second group may have a rectangular formation, a third group may have a triangular formation, etc. The formation of the groups may depend on the location and trajectory (308) of the signal source (304). In the example shown in FIG. 3A, each of the groups have a line formation and four groups of the UAVs (i.e., Groups 1 to 4) (302) form rectangular scan sub-area 1 (300). Each scan sub-area includes several scan points (301) where the UAVs will record data. The signal source (304) moves along its trajectory (308) to produce the signal that is subject to recording by the UAVs.

At each emission point (305), the signal source (304) produces a signal, which is an acoustic wave in this example. When the signal source (304) moves from one emission point (305) to the next emission point (305), the UAVs also move to the next scan sub-area that corresponds to the next emission point (305) to record data. For example, as shown in FIG. 3A, when the signal source (304) is in the initial position (the location of the signal source (304) shown on FIG. 3A), Groups 1 to 4 of the UAVs are arranged in scan sub-area 1 to record data that corresponds to the initial position of the signal source (304), to scan sub-area 1. When the signal source (304) moves to the next emission point (305) that is adjacent to the initial position of the signal source (304) (i.e., the emission point (305) that is at the center of scan sub-area 2), Group 1 of the UAVs fly (303.1) to the bottom row of scan sub-area 2. Then, the signal source (304) emits signal at the emission point (305) that is at the center of scan sub-area 2 and Groups 1 to 4 of UAVs record data that corresponds to scan sub-area 2. Then, in a similar manner, the signal source (304) moves to the next emission point (305) that is at the center of scan sub-area 3 and Group 2 of the UAVs fly (303.2) to the bottom row of scan sub-area 3. Then, the signal source (304) emits signal at the emission point (305) that is at the center of scan sub-area 3 and Groups 1 to 4 of UAVs record data that corresponds to scan sub-area 3. In a similar manner, when the signal source (304) moves to the next emission points that are at the centers of scan sub-areas 4 and 5, Groups 3 and 4 fly (303.3, 303.4) to cover empty regions of scan sub-areas 4 and 5 and record data of scan sub areas 4 and 5, respectively. This procedure continues until Groups 1 to 4 cover scan sub area N (307), which is the last scan sub-area in the geophysical exploration. This way, by moving Groups 1 to 4 of the UAVS sequentially with the signal source (304) along the trajectory (308) of the signal source, the UAVs can scan all the exploration area, which covers scan sub-areas 1 to N.

FIG. 3B shows another example of exploration of UAVs, in accordance with one or more embodiments disclosed herein. This example is for seismic data acquisition, where target positions are located on 8 linear profiles with 45 degrees offset from one another over the ground. Each linear profile includes 19 points and the signal source(s) are disposed at the center. Each adjacent pair of points are 10 meters (m) apart on each linear profile. All of the linear profiles are disposed over the target positions for data recording. 16 UAVs fly from the initial positions surrounding the signal source(s) along the linear profiles (2 on each of the 8 linear profiles). The initial positions are located 10 m and 20 m away from the signal source(s) on each of the 8 linear profiles. The UAVs fly forming an expanding circle to record data in all of the exploration area, while the signal source(s) remain at the center. For this, the UAVs may fly in the same manner discussed above with reference to FIG. 3A. Specifically, in each data recording step, the inner circle of the UAVs may fly to the next available outer circle and then the UAVs record data. This process may continue until the UAVs record data from all of the target positions. Alternatively, both the inner circle and outer circle of the UAVs may fly together to the next two available circles to record data, and this process may continue until the UAVs record data from all of the target positions.

While the example described above with reference to FIG. 3B describes flight of the UAVs outward to expand the circles, alternatively in one or more embodiments the UAVs can fly inward to shrink the circles.

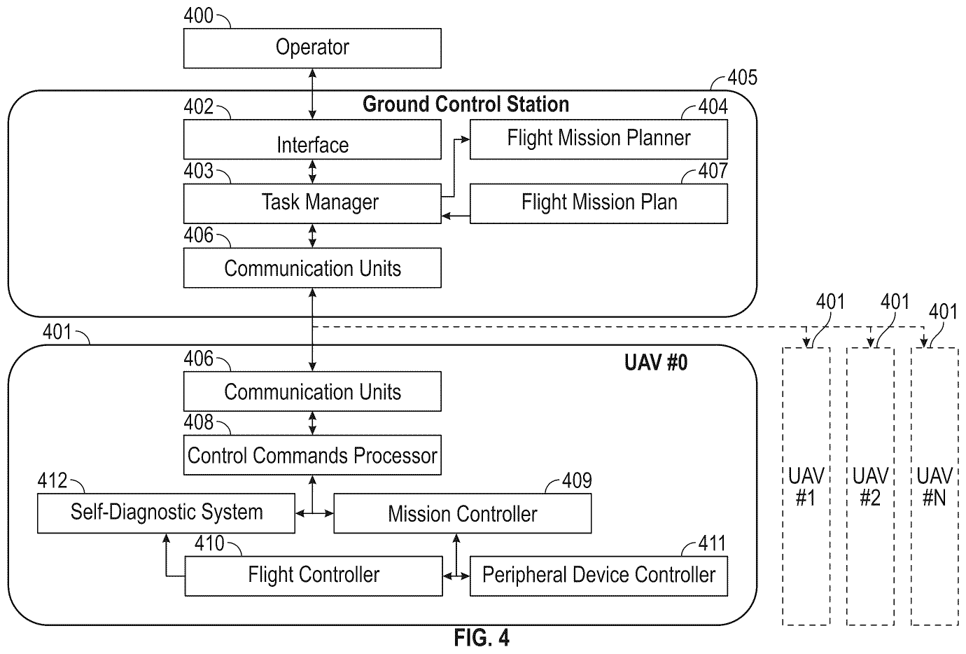

FIG. 4 shows block diagrams of the control station (405) (which is a GCS in this example) and UAVs (401), in accordance with one or more embodiments disclosed herein. According to FIG. 4, an operator (400) enters the parameters of an exploration area using an interface (402). The parameters may be, for example global coordinates, formation of the exploration area, width of the exploration area, length of the exploration area, height of the exploration area, the number of UAVs (401) used in the mission, recording parameters (e.g., recording time, signal listening time, special and temporal accuracy tolerance, blended source signal time-distance rule, or seismic source characteristics), type of sensor(s) for geophysical exploration (peripheral devices), communication protocol, etc. The parameters may further include the UAV parameters and characteristics (e.g., maximum flight time, flight velocity, battery consumption, size, etc.), minimum flight distance between UAVs in groups, mission timeline, mission timeline, the position of the ground control station, ground altitudes of the target flight area, weather conditions, position of obstacles (e.g., industrial buildings, construction, nature terrains, etc.), etc.

A task manager (403), which is a program of the control station (405), checks the parameters and transfers them to a flight mission planner (404) to generate flight mission plan (407). Then UAVs (401) communicate with the control station (405), regarding their coordinates at their initial positions, using communication units (406). The communication units (406) of the control station and of the UAVs may be transceivers, or transmitters and receivers, that can communicate (transmit/receive) signal between the control station and the UAVs. The transceiver of the UAV may be referred to as the first transceiver and the transceiver of the control station may be referred to as the second transceiver, for simplicity. The task manager (403) checks the UAVs' readiness and the correctness of their coordinates at their initial positions. The flight mission planner (404) generates a grid with landing and acquisition positions. The grid is the map of the target positions of the UAVs. Examples of the grid (target positions (107, 206)) are described above with reference to FIGS. 1, 2, 3A, and 3B. The flight mission planner (404) assigns UAVs' target positions, plans their trajectories, and generates a flight mission plan (407) for various groups of the UAVs and for each of the UAVs (401) individually. For example, the control station (405) provides the mission plan in the form of a plurality of tasks that are included in one or more lists and transmits the task lists to the UAVs (401) according to their identifications (ID).

Operations performed inside the control station (405) such as operations of the task manager (403) and flight mission planner (404) can be performed by one or more processors (e.g., a second processor) of the control station (405). The one or more processors of the control station use the communication unit(s) (406) of the control station (405) to communicate with (send signal to or receive signal from) the UAVs (401). The flight mission plan (407) are used in the program to track the progress of the mission at the control station (405).

After successful transfer of all data to the UAVs (401), the operator (400) confirms the launch of the mission through the interface (402) and sends a command to the UAVs (401) to start the mission. The control commands processor (408) of the UAVs (401) starts autonomous control mode, during which the mission controller (409) follows the flight mission plan (407) autonomously. The mission controller (409) launches the UAVs (401) by sending commands to a flight controller (410) and activates a peripheral device controller (411) according to the flight mission plan (407). Operations performed inside each UAV (401) such as operations of the control commands processor (408), self-diagnostic system (412), mission controller (409), flight controller (410), and peripheral device controller (411) can be performed by one or more processors (e.g., a first processor) of the UAV (401). The one or more processors of the UAV (401) use the communication unit(s) (406) of the UAV (401) to communicate with the control station (405).

The operator (400) monitors execution of the tasks by the UAVs (401) in the interface (402). In case of unexpected behavior by any of the UAVs (401) or occurrence of a situation requiring emergency intervention, the operator (400) can send an emergency landing command to all or specific UAVs (401). The behavior of the UAVs (401) and their missions can be tracked by the self-diagnostic system (412).

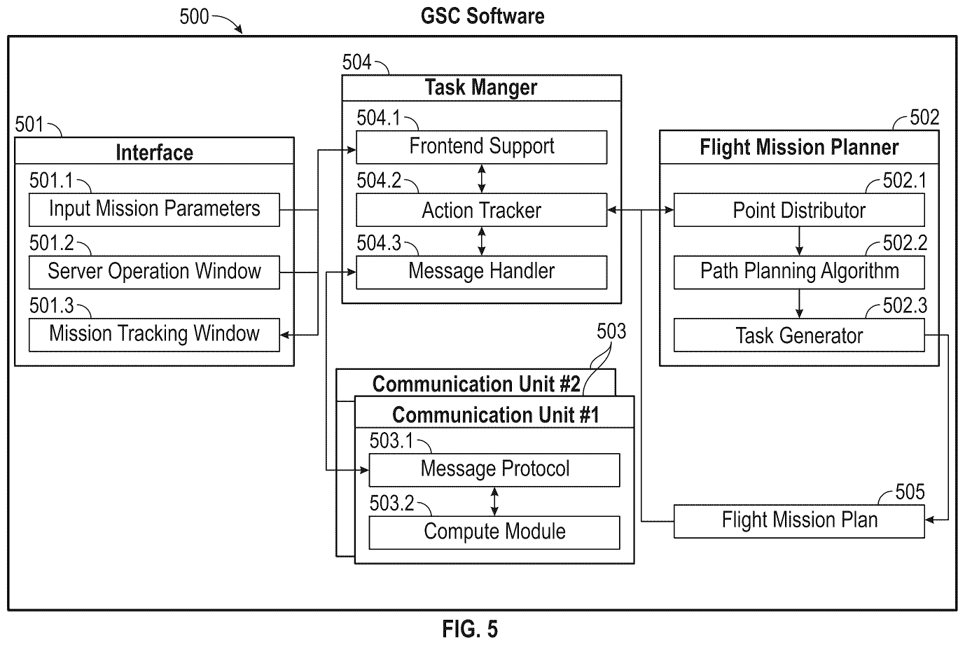

FIG. 5 shows a block diagram of software (500) of a control station, which is GCS in this example, in accordance with one or more embodiments disclosed herein. The software (500) includes subsystems such as an interface (501), a flight mission planner (502), a communication system (503), and a task manager (504). The interface (501) may be a graphical or terminal user interface. An operator enters input mission parameters (501.1) and tracks, in server operation window (501.2) of the interface (501), UAVs that are connected to the control station. The operator can also track real-time information about stages of the mission in mission tracking window (501.3). Examples of the stages of the mission may be positions and statuses of the UAVs, correctness of the UAV positions in the launch area, etc.

A task manager (504) identifies target task IDs of the UAVs, tracks the status of each of the UAVs in its respective group, and assigns tasks or handles emergency situations during the mission based on the target task IDs. The task manager (504) supports user interface with backend computations in the frontend support block (504.1). The task manager (504) allows to consistently lead a mission in the order that is defined in the geophysical exploration. An action tracker (504.2) distributes data and activates a flight mission planer (502). The flight mission planer (502) includes a point distributer (502.1) to distribute coordinates (e.g., target positions) to the UAVs, a path planning algorithm (502.2) to determine trajectories of the UAVs for the mission, and a task generator (502.3) to generate the tasks that the UAVs must perform (e.g., landing, take-off, data recording, etc.). The action tracker (504.2) also prepares a flight mission plan (505) and redirects and sends it to the UAVs through a message handler (504.3).

The message handler (504.3) contacts (i.e., communicates with) each UAV using the communication units (503). In response, the UAVs send their current status (e.g., in flight, grounded, data recording, etc.), battery charge level, coordinates, current task IDs, etc. to the message handler (504.3). In case of a faulty UAV (e.g., low battery level), the faulty UAV flies to the base or a launch area and a spare UAV is sent on the mission instead. This replacement of the faulty UAV with a spare UAV can also occur in the event of loss of communication with the UAV. The faulty UAV is a UAV that is unable to properly handle the mission due to component failure, loss of communication, or battery failure for example when the battery charge is below a threshold. The threshold may be defined by the control station according to requirements of the mission such as flight time, data recording time, etc.

Communication between the UAVs and the control station is carried out in single or several independent ways through communication units (503). To this end, all messages may be encrypted in accordance with a message protocol (503.1). A compute module (503.2) prepares the data for transmission to the UAVs. In one implementation, the UAVs can be connected to the control station via wireless network protocols (Wi-Fi) based on IEEE 802.11 protocol at short distance (i.e., short range) that can be handled under this protocol, or via radio communication at a Long Range Wireless Technology (LoRa). In one or more embodiments, the control station or any of the UAVs may include the two aforementioned types of transceivers in one combined module or in several independent modules.

One benefit of using different communication types of transceivers is to increase the reliability of communication and the possibility of transmitting a large amount of data between the control station and the UAVs. For example, short distance communication provides greater bandwidth and allows exchange of service files or data (e.g., recording data) communication between the UAV and the control station. In this approach, the UAVs are “clients” on a transmission control protocol (TCP) server, which operates within the software (500) of the control station. In addition, the long distance radio communication can be used to exchange control commands or status messages between the control station and the UAVs to have reliable control over the UAVs over long distances.

In one or more embodiments, the mission plan can be divided into a number of tasks by the task generator (502.3). For example, the tasks may include initialization of the UAVs, flight of the UAVs based on coordinates, recording data by UAV sensors, flying to a next scanning position, landing at a target position, returning to the base, etc. The output of the flight mission planner (502) is a file with a set of task lists (505) assigned to each UAV. Each task in the flight mission plan (505) includes an ID, a task code, a list of flight coordinates, and timestamps for the mission. In case of long distance flights or low communication bandwidth, the control station can send a small array of data, such as task IDs and timestamps to the UAVs and thereby maintain necessary operations and communications between the UAVs and the control station to perform the mission.

FIG. 6 shows a block diagram of software (600) of a UAV, in accordance with one or more embodiments disclosed herein. The software (600) includes a control commands processor (601), a mission controller (602), peripheral device controllers (603), a flight controller (604), a self-diagnostic system (605), and communication units (606).

The UAV receives control commands from the control station via the communication units (606). The communication units (606) of the UAVs handle receiving (or transmitting) a message from (to) the communication unit of the control station via a compute module (606.1) and decrypting the signal in accordance with a message protocol (606.2). The content of the message is analyzed by a message analyzer (601.1), and thereafter a decision making system (601.2) operates based on this message. In case of starting an autonomous mission, the decision making system (601.2) activates the mission controller (602). The mission controller (602) follows the flight plan prepared via a flight plan reader (602.1), communicates with the peripheral device controllers (603) via control device drivers (603.1), and coordinates the flight process by sending commands to a control device driver (604.2) of the flight controller (604). Also, a state checker (605.2) checks service data about UAV status (e.g., status of the UAV propulsion system, battery charge, localization data availability, current position, etc.) from the flight controller (604) and peripheral device controllers (603). Then, the self-diagnostic system (605) generates a status message (605.1) and transmits it to an action tracker (601.3) that analyzes state of UAV subsystems. In case of failure of communication with the control station, which is tracked in the compute module (606.1) via the state checker (605.2), the UAV can go to full autonomous mode or emergency landing.

During the mission, the UAV follows the flight mission plan and mission trajectories via a path-following algorithm (602.2). The UAV can be equipped with sensors (e.g., an infrared sensor, an ultraviolet sensor, a distance sensor such as LiDAR, a camera, GPS, etc.), which are connected to the peripheral device controller (603), to detect obstacles and solve local path planning tasks. This will allow the UAV to fly around unforeseen and unpredictable obstacles and determine the landing site. The UAV's position is determined by its navigation system (604.1). The navigation system (604.1) may be, for example, a Global Navigation Satellite System (e.g., GPS), a Real Time Kinematic system, onboard localization algorithms, etc. The UAV can also determine whether it is possible to land at the intended coordinates using the onboard sensors. If landing is not possible or not allowed, the UAV can land where it is possible or allowed. For example, the UAV may land close to a given point, or as a last resort move to the next mission point. After landing, the UAV deploys sensors to conduct geophysical exploration.

When the UAV receives a data recording command, the UAV starts performing geophysical exploration by one or several sensors (e.g., seismic sensors, electromagnetic antenna, geophones, accelerometers, microelectromechanical systems (MEMS), gravimeters, spectrometer for radiation detection on ground surface, etc.), which may be connected to the peripheral device controllers (603). All collected data can be stored in an internal storage (603) or sent by the communication unit (606) to the control station. When the geophysical exploration of one scan target position is finished, the UAV flies to the next scan target position. During the entire mission, the UAV sends the mission status to the control station using short range wireless communication or long range radio protocol. In some cases (e.g., during electromagnetic or gravity exploration), the UAV can perform surveys (exploration) by hovering over the target positions instead of landing.

For performing autonomous flight and navigation, the UAV may be equipped with visual based sensors (e.g., RGB-D camera, LiDAR, range sensors, etc.). Additionally, the peripheral devices may include supporting mechanisms, such as landing gears, sensor deploying systems, payload drop devices, etc. In some embodiments, each of these mechanisms may require its own peripheral device controller and control interface for execution of autonomous missions.

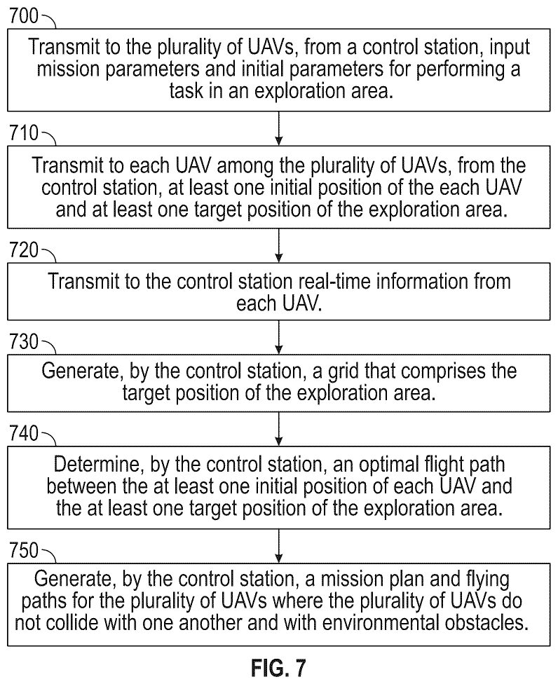

FIG. 7 shows a flowchart for operating a system that includes the control station and UAVs described herein in accordance with one or more embodiments. In one or more embodiments, one or more of the steps shown in FIG. 7 may be omitted, repeated, or performed in a different order than the order shown in FIG. 7. Accordingly, the scope of the invention should not be considered limited to the specific arrangement of the steps shown in FIG. 7. The steps shown in FIG. 7 are explained below.

In Step 700, the control station receives, from an operator, input mission parameters and initial parameters for performing a task in an exploration area. The task may be geophysical exploration (e.g., at least one target position of the exploration area) as described above, for example with reference to FIGS. 1-6.

In Step 710, the control station receives, from each UAV among the plurality of UAVs, at least one initial position of the UAV, ID, and current robot status (e.g., ready, discharged, poor GPS signal, error, etc.) of the UAV.

In Step 720, each UAV transmits to the control station real-time information (e.g., position, status, etc.).

In Step 730, the control station generates a grid that includes the at least one target position of the exploration area, for example as described above with reference to FIGS. 1-6.

In Step 740, the control station determines an optimal flight path between the at least one initial position of each UAV and the at least one target position of the exploration area, for example as described above with reference to FIGS. 1-6. Each UAV receives the optimal flight path and the at least one target position of the area from the control station.

In Step 750, the control station generates a mission plan and flying paths for the plurality of UAVs where the plurality of UAVs does not collide with one another and with environmental obstacles, for example as described above with reference to FIGS. 1-6. The plurality of UAVs receives the mission plan and flying paths from the control station.

The method may include additional steps, in accordance with one or more embodiments, as disclosed herein. For example, the method may include grouping the plurality of the UAVs, by the control station, into a plurality of groups, dividing the mission plan into a plurality of group tasks, and assigning the plurality of group tasks respectively to the plurality of groups. The control station may group the plurality of UAVs based on their IDs. The control station may assign each group respective target positions and trajectories for performing a group task, based on the IDs of UAVs of each group. The control station may determine spatial formation of each of the plurality of groups based on requirements of the mission plan. Examples of these steps are disclosed above with reference to FIGS. 2, 3A, and 3B in accordance with one or more embodiments.

The method may include scheduling, by the control station, UAV battery replacement or scheduling replacement of a faulty UAV with a spare UAV. The control station can monitor battery charge of each UAV. When the battery charge of a low-charge UAV is below a threshold, the control station replaces the low-charge UAV with a spare UAV located in a launch area or at the base and sends the spare UAV along a new trajectory for replacing the low-charge UAV. The control station can plan battery replacement in the lunch area or base such that batteries of a last row of UAVs of the launch area or base are replaced first, and after departure of all of the UAVs located in the last row from the launch area or base, the control station plans battery replacement of a row next to the last row and so forth. Examples of these steps are described above with reference to FIG. 1.

Further, when a faulty UAV cannot continue performing a task assigned to the UAV, the control station can replace the faulty UAV with a spare UAV located in the launch area or base and send the spare UAV along a new trajectory for replacing the faulty UAV. Example of these steps are disclosed above with reference to FIG. 1.

The method may include self-diagnosing, by one or more UAVs or all of the plurality of UAVs, correctness of parameters received from the control station for geophysical exploration and monitoring status of the UAV in real-time. Examples of these steps are disclosed above with reference to FIGS. 4 and 6.

The method may include calculating, by the control station, a minimum flight time of each UAV and the shortest (minimum) flight path to the at least one target position and determining flight paths of the plurality of UAVs such that the plurality of UAVs does not collide with one another during the mission plan. These steps can be performed by the flight mission planner (502), which is described above with reference to FIG. 5.

The method may include generating, by the control station, a grid with landing and acquisition points (i.e., target positions) for the plurality of UAVs. Examples of the grid and the landing and acquisition points (107, 206, 301) are described above with reference to FIGS. 1, 2, 3A, and 3B. The control station may assign each group of the UAVs target positions and trajectories for performing the group task and individual tasks, based on IDs of the UAVs of the each group.

The method may include dividing the exploration area, by the control station, into a plurality of sub-areas. Each sub-area may incorporate one or more groups of UAVs among the plurality of UAVs for scanning the sub-area. The control station can arrange the one or more groups of UAVs to form a shape that is determined based on requirements of the exploration or based on location or trajectory of a signal source. Examples of these steps are described above with reference to FIGS. 2, 3A, and 3B. When the signal source moves from a first point to a second point on the trajectory of the signal source, the one or more groups of UAVs move from a first sub-area to a second sub-area along the trajectory of the signal source. When the signal source moves from the first point that corresponds to the first sub-area to the second point that corresponds to the second sub-area on the trajectory of the signal source, a first group of UAVs among the plurality of groups of UAVs fly to an empty region of the second sub-area, and then the plurality of UAVs records data. Examples of these steps are described above with reference to FIG. 3A.

The method may further include generating, by the control station, a file that includes a list of tasks respectively assigned to the plurality of UAVs and a global task that is for tracking real-time status of geophysical exploration. Examples of this step are described above with reference to FIGS. 2, 4, and 5.

One or more embodiments disclosed herein for operating the control station and UAVs, for example with reference to FIGS. 1-7, may be implemented on virtually any type of computer system, regardless of the platform being used. The computer system may have programs or algorithms to control the functions/operations of the control station and UAVs described in the above embodiments. For example, the computer system may be one or more mobile devices (e.g., laptop computer, smart phone, personal digital assistant, tablet computer, or other mobile device), desktop computers, servers, blades in a server chassis, or any other type of computer system that includes at least the minimum processing power, memory, and input and output device(s) to perform one or more embodiments of the invention.

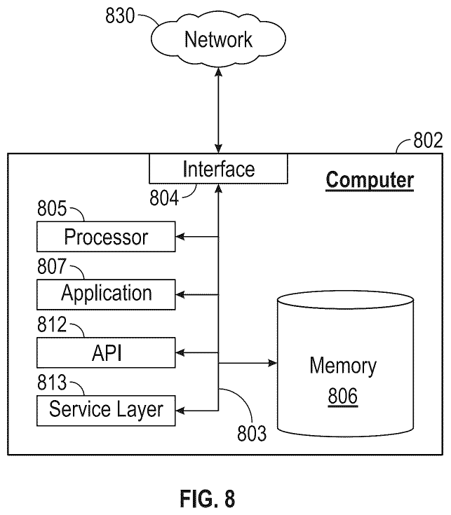

An example of the computer system is described with reference to FIG. 8, in accordance with one or more embodiments. FIG. 8 is a block diagram of a computer system used to provide computational functionalities associated with described algorithms, methods, functions, processes, flows, and procedures as described in the instant disclosure, according to an implementation. The illustrated computer (802) in the computer system is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. The illustrated computer (802) is communicably coupled with a network (830). In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802)) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813)). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer (813). Software services, such as those provided by the service layer (813), provide reusable, defined business functionalities through a defined interface. For example, the interface may be software written in JAVA, C++, Python, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). For example, memory (806) can be a database storing data consistent with this disclosure. In one example, memory (806) may store programs or algorithms for controlling operation of the control station or UAVs described above in accordance with one or more embodiments with reference to FIGS. 1-7. For example, the programs or algorithms may control operation of the control station described with reference to FIG. 5 or operation of the UAVs described with reference to FIG. 6. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, the application (807) can serve as one or more components, modules, applications, etc. In one example, the application (807) may include programs or algorithms for controlling operation of the control station or of the UAVs described above in accordance with one or more embodiments with reference to FIGS. 1-7. For example, the programs or algorithms may control operation of the control station described with reference to FIG. 5 and operation of the UAVs described with reference to FIG. 6 in accordance with one or more embodiments. Further, although illustrated as a single application (807), the application (807) may be implemented as multiple applications (807) on the computer (802). In addition, although illustrated as integral to the computer (802), in alternative implementations, the application (807) can be external to the computer (802). In one example, the method described with reference to FIG. 8 may be implemented by the application (807).

There may be any number of computers (802) associated with, or external to, a computer system containing computer (802), each computer (802) communicating over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802). Furthermore, in one or more embodiments, the computer (802) is a non-transitory computer readable medium (CRM).

The control station software and UAV software described above with reference to FIGS. 5 and 6, as well as the method described with reference to FIG. 7, can be implemented on the computer system described above with reference to FIG. 8.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system for controlling a plurality of unmanned arial vehicles (UAV), the system comprising:
the plurality of UAVs, wherein each of the plurality of UAVs comprises a first processor and a first transceiver; and
a control station comprising a second processor and a second transceiver, wherein:
the first transceiver receives, from the second transceiver, input mission parameters for performing a task in an exploration area,
the first transceiver receives, from the second transceiver, at least one initial position of each UAV and at least one target position of the exploration area,
the second processor determines an optimal flight path between the at least one initial position of each UAV and the at least one target position of the exploration area,
the second processor generates a grid that comprises the at least one target position of the exploration area, and
the second processor generates a mission plan and flying paths for the plurality of UAVs where the plurality of UAVs does not collide with one another and with environmental obstacles.

2. The system according to claim 1, wherein the mission plan comprises the at least one task for each UAV, moving coordinates for each UAV, the at least one target position for each UAV, and timestamps for completing the task for each UAV.

3. The system according to claim 1, wherein
the control station groups the plurality of the UAVs into a plurality of groups, and
the control station divides the mission plan into a plurality of group tasks and assigns the plurality of group tasks respectively to the plurality of groups.

4. The system according to claim 3, wherein the control station determines spatial formation of each of the plurality of groups based on requirements of the mission plan.

5. The system according to claim 1, wherein the control station schedules UAV battery replacement.

6. The system according to claim 1, wherein the mission plan is a geophysical exploration.

7. The system according to claim 1, wherein the first processor self-diagnoses correctness of parameters received from the control station for geophysical exploration and monitors status of each UAV in real-time.

8. The system according to claim 1, wherein
the second processor calculates a minimum flight time for each UAV and the shortest flight path to the at least one target position,
and the second processor determines flight paths of the plurality of UAVs such that the plurality of UAVs does not collide with one another during the mission plan.

9. The system according to claim 1, wherein when a faulty UAV among the plurality of UAVs cannot continue performing the task, the control station replaces the faulty UAV with a spare UAV located in a launch area and sends the spare UAV along a new trajectory for replacing the faulty UAV.

10. The system according to claim 1, wherein
the control station monitors battery charge of each UAV, and
when the battery charge of a low-charge UAV is below a threshold, the control station replaces the low-charge UAV with a spare UAV located in a launch area and sends the spare UAV along a new trajectory for replacing the low-charge UAV.

11. The system according to claim 10, wherein
the control station plans battery replacement in the lunch area such that batteries of a last row of UAVs in the launch area are replaced first, and
after departure of all of the UAVs located in the last row from the launch area, the control station plans battery replacement of a row next to the last row and so forth.

12. The system according to claim 1, wherein
the control station generates the grid that includes landing and acquisition points for the plurality of UAVs,
the control station groups the plurality of UAVs into a plurality of groups based on identifications (ID) of the plurality of UAVs, and
the control station assigns each group of the plurality of groups target positions and trajectories for performing a group task, based on IDs of UAVs of the each group.

13. The system according to claim 1, wherein the plurality of UAVs communicates with the control station via a wireless network protocol (Wi-Fi) that operates in short range and via radio waves corresponding to a Long Range Wireless Technology (LoRa) in long range.

14. The system according to claim 13, wherein Wi-Fi is used for exchanging service files or recording data and LoRa is used to exchange control commands or status messages between the control station and the plurality of UAVs.

15. The system according to claim 1, wherein
each UAV is equipped with one or more sensors that detect obstacles, and
the one or more sensors are one or more of the list consisting of a camera, an infrared sensor, an ultraviolet sensor, a distance sensor, and a Global Positioning System (GPS).

16. The system according to claim 1, wherein
the control station divides the exploration area into a plurality of sub-areas,
each sub-area incorporates one or more groups of UAVs among the plurality of UAVs for scanning the each sub-area,
the control station arranges the one or more groups of UAVs to create a formation that is determined based on requirements of the mission plan or based on location or trajectory of a signal source, and
when the signal source moves from a first point to a second point on the trajectory of the signal source, the one or more groups of UAVs move from a first sub-area among the plurality of sub-areas to a second sub-area among the plurality of sub-areas along the trajectory of the signal source.

17. The system according to claim 16, wherein
each sub-area incorporates a plurality of groups of UAVs among the plurality of UAVs for scanning the each sub-area,
when the signal source moves from the first point that corresponds to the first sub-area to the second point that corresponds to the second sub-area on the trajectory of the signal source, a first group of UAVs among the plurality of groups of UAVs flies to an empty region of the second sub-area and then, the plurality of groups of UAVs records data.

18. The system according to claim 1, wherein
the control station positions the plurality of UAVs in an initial scanning circle around a stationary signal source, and
the plurality of UAVs flies inward or outward from the initial scanning circle to a next scanning circle that is concentric with the initial scanning circle.

19. A method for controlling a plurality of unmanned arial vehicles (UAV), the method comprising:
transmitting to the plurality of UAVs, from a control station, input mission parameters for performing a task in an exploration area;
transmitting to each of the plurality of UAVs among the plurality of UAVs, from the control station, at least one initial position of the each UAV and at least one target position of the exploration area;
transmitting to the control station real-time information from each UAV;
determining, by the control station, an optimal flight path between the at least one initial position of each UAV and the at least one target position of the exploration area;
generating, by the control station, a grid that comprises the at least one target position of the exploration area; and
generating, by the control station, a mission plan and flying paths for the plurality of UAVs where the plurality of UAVs does not collide with one another and with environmental obstacles.

20. A non-transitory computer readable medium (CRM) storing instructions for performing operation that controls a plurality of unmanned arial vehicles (UAV), the operation comprising:
transmitting to the plurality of UAVs, from a control station, input mission parameters for performing a task in an exploration area;
transmitting to each of the plurality of UAVs among the plurality of UAVs, from the control station, at least one initial position of the each UAV and at least one target position of the exploration area;
transmitting to the control station real-time information from each UAV;
determining, by the control station, an optimal flight path between the at least one initial position of each UAV and the at least one target position of the exploration area;
generating, by the control station, a grid that comprises the at least one target position of the exploration area; and
generating, by the control station, a mission plan and flying paths for the plurality of UAVs where the plurality of UAVs does not collide with one another and with environmental obstacles.
